(19) United States
(12) Patent Application Publication
(10) Pub. No.: US 2003/0155553 A1
(43) Pub. Date: Aug. 21, 2003

(54) Long persistent phosphor incorporated within a non-settable material

(76) Inventors: Bradford K. Mortz, Cave Creek, AZ (US); Robert H. Miller, Canton, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/149,465

(22) PCT Filed: Dec. 7, 2000
(86) PCT No.: PCT/US00/42692

(51) Int. Cl. C09K 11/02; C09K 11/08

(52) U.S. Cl. 252/301.4 S; 252/301.36; 252/301.4 R; 252/301.4 F; 501/32

(57) ABSTRACT

A process for incorporating a long persistent phosphor within a non-settable material includes firing a doped phosphor to obtain a phosphor having a persistence that ranges from minutes to hours. The fired phosphor is then ground into a phosphor particulate having a mean domain size. Typical particulate mean domain size ranges from 1 to 60 microns. The phosphor particulate is thereafter encapsulated within a water impervious coating material such as silicon oxide or fluoride. The coated phosphor particulate is then mixed in a specified volume ratio within the non-settable material. Typical formulation ratios range from 0.1 to 30 volume percent of particulate.

### BACKGROUND OF THE INVENTION

1. Field of the Invention

The present invention relates generally to phosphorescent based materials and, more particularly, to a process and product by process for incorporating a long persistent phosphor within a non-settable material.

2. Description of the Prior Art

Various types of phosphor materials are well known in the art and which provide varying degrees of persistent luminescence. A common objective of phosphor materials is to provide an application for a luminescent light source which takes advantage of intermittent light irradiation and/or the absence of irradiating light on a continuous basis.

While the existence of phosphor materials such as above is fairly well known in the art, the recent trend has been to identify useful applications of persistent phosphor which will enable the production of production of sufficient light illumination following an iterative period of light irradiation.

### SUMMARY OF THE INVENTION

A process for incorporating a long persistent phosphor within a non-settable material includes firing a doped phosphor to obtain a phosphor having a persistence that ranges from minutes to hours. The fired phosphor is then ground into a phosphor particulate having a mean domain size. The phosphor particulate is thereafter encapsulated within a water impervious coating material. The coated phosphor particulate is then mixed in a specified volume ratio within the non-settable material.

A phosphorescent settable formulation includes 0.1 to 30 volume percent of a long persistent doped sulfide phosphor particulate having a mean particle domain size of between 1 and 60 microns. The particulate has a water impervious silicon oxide or fluoride coating thereover. A non-settable material carrier is provided for the particulate.

A method of forming a phosphorescent solid is also provided based upon setting of an inventive formulation.

### DETAILED DESCRIPTION OF THE PREFERRED EMBODIMENTS

The present invention is a process, as well as a product produced by a process, for incorporating a long persistent phosphor within a non-settable host material. A significant number of different non-settable materials are capable of being utilized with the phosphorescent material. As used herein “non-settable is defined to mean those substances that reversibly undergo phase transformation without a change in composition or bonding.

As used herein “long persistence” is defined to mean a phosphorescence lifetime greater than 1 minute. Non-settable materials illustratively include thermoplastics, oils, waxes glasses, solvents, greases, lubricants, ceramics, chalk, metals and metal alloys melting below 600° C. It is appreciated that additives to the non-settable material carrier illustratively optionally include antioxidants, fillers, dyes, pigments, and plasticizers.

The long persistent phosphorescent material is constituted by any of a number of various chemical compositions as are known in the art. The phosphor is typically provided as a powderized or granulate material and, in one instance, may include a lime green phosphor produced under the commercial name Nemoto Luminova and consisting of a strontium aluminate material. Additional Luminova colors include blue and which is constituted by a recipe of a Calcium Strontium Aluminate, and which is doped with Europium.

Other phosphors may specifically include a strontium sulfide material which is fired in an inert crucible at a selected elevated temperature and for a determined time period. To achieve the desired level of long persistence, as well as a given color, a dopant is added to the phosphor. While dopant precursors are typically slurried with phosphor precursors prior to firing, it is appreciated that dopants are also intercalated into a phosphor through exposing a fired phosphor to a dopant. Post firing dopant addition illustratively occurs through solution surface coating or ion implantation. Experimentation of different dopants has determined that a Europium dopant will achieve a persistent phosphor having an orange/red color. Dopants are typically present from 0.1 to 5 atomic percent. Often it is desirous to include a second dopant to enhance persistence lifetimes or modify phosphor color. As is also well known in the art, additional types of dopants may include alumina, lanthanide oxides, fluorides and chlorides and are capable of yielding persistent phosphors having pale yellow and purple shades. Further, the use of varying percentages of Calcium with Strontium Sulfide will achieve additional color shades leading to a purer red color.

Following the crucible firing of the doped phosphor, the persistent phosphor composition is dried and is retrieved in a rock-like form. A subsequent crushing and grinding operation reduces the particle domain size to a preferred range of 9 to 60 microns. More preferably, the particle mean domain size is from 9 to 45 microns. Certain paint or solvent based applications require particular sizes to be reduced to, in some instances, down to 1 micron in size. Prior to introducing the phosphorescent particles into a host material, it is desirable to coat or encapsulate them so as to ensure its long term performance. It has been found that moisture, over time, tends to degrade the ability of the phosphor to maintain its long-term performance.

Accordingly, one or more types of encapsulation techniques are employed to coat the individual phosphor granulates. A first type of encapsulation is provided by a silicon oxide applied during a firing temperature of 800° C. A fluoride material may be applied contemporaneously with or separately from the silicon oxide. Typically, a firing temperature of approximately 700° C. is best suited for application of fluoride. Other encapsulation techniques may employ organic chlorosilanes in hexane or heptane solvents. The process steps in which the encapsulation of the material is accomplished typically includes mixing the coating powder with the substrate powder in an appropriate ratio, firing the mixed powder at the prescribed temperature for a defined time, washing the fired powder to remove the uncoated portion of the core powder, and drying the washed powder. Additional encapsulation techniques are illustratively detailed in U.S. Pat. Nos. 4,710,674; 5,049,408; 5,196,229; 5,118,529; 5,113,118 and 5,220,341.

By way of example, 2 volume percent of strontium sulfide doped with europium and dysprosium red phosphor particles having a mean particle size of 2 microns and a silica water impervious overcoat is dispersed in a lubricant formulation as detailed in U.S. Pat. No. 4,242,095. A stable, long persistence phosphorescing lubricant results.

Any patents mentioned in the specification are indicative of the levels of those skilled in the art to which the invention pertains. These patents are herein incorporated by reference to the same extent as if each individual patent was specifically and individually incorporated by reference.

Having described our invention, it will become apparent that it teaches a novel and useful process and product by process for incorporating a long persistent phosphor, such as in a particulate form, within a non-settable host material. Many and numerous additional embodiments will become apparent to those skilled in the art to which it pertains without deviating from the scope of the appended claims.

We claim:

1. A process for incorporating a long persistent phosphor within a non-settable material, comprising the steps of:
firing a doped phosphor;
grinding said doped phosphor into a phosphor particulate having a mean domain size;
encapsulating said phosphor particulate within a water impervious coating material; and
mixing a specified volume ratio of said encapsulated phosphor particulates within the non-settable material.

2. The process according to claim 1, wherein said phosphor is Strontium Sulfide with a Europium dopant.

3. The process according to claim 1, wherein said phosphor is a mixed Calcium Strontium Sulfide.

4. The process according to claim 1, wherein said phosphor particulate is encapsulated within a fluoride coating.

5. The process according to claim 1, wherein said phosphor particulate is encapsulated within a silicon oxide coating.

6. The process according to claim 1, wherein said phosphor particulate is ground to a mean domain size of 30 to 60 microns.

7. A phosphorescent non-settable formulation comprising:
0.1 to 30 volume percent of a long persistent doped sulfide phosphor particulate having a mean particle domain size of between 1 and 60 microns, said particulate having a water impervious coating thereover selected from the group consisting of: silicon oxide and fluoride; and
a non-settable material carrier for said particulate.

8. The formulation according to claim 8 wherein said particulate is present from 5 to 20 volume percent.

9. The formulation according to claim 8 wherein said particulate is present from 10 to 20 volume percent.

10. The formulation according to claim 8 wherein said particulate is strontium sulfide doped with europium.

11. The formulation according to claim 11 further comprising a second lanthanide dopant.

12. The formulation according to claim 8 wherein the mean particle domain size is between 9 and 45 microns.

13. The formulation according to claim 8 wherein said non-settable material carrier is selected from the group consisting of: thermoplastics, oils, waxes glasses, solvents, greases, lubricants, ceramics, chalk, metals and metal alloys melting below 600° C.

14. A formulation of claim 1 obtainable by the process of claim 8.
